(19) United States
(12) Patent Application Publication
(10) Pub. No.: US 2015/0299500 A1
(43) Pub. Date: Oct. 22, 2015

(54) CURABLE COMPOSITION CONTAINING SILICON-CONTAINING HIGHLY-BRANCHED POLYMER

(71) Applicant: NISSAN CHEMICAL INDUSTRIES, LTD., Tokyo (JP)

(72) Inventors: Masayuki HARAGUCHI, Funabashi-shi (JP); Motonobu MATSUYAMA, Funabashi-shi (JP)

(21) Appl. No.: 14/433,092

(22) PCT Filed: Oct. 2, 2013
(86) PCT No.: PCT/JP2013/076835

§ 371 Date: Jun. 18, 2015

(30) Foreign Application Priority Data
Oct. 2, 2012 (JP) 2012-220455

(51) Int. Cl. C09D 133/08; B05D 1/02; B05D 3/06

(52) U.S. Cl. CPC C09D 133/08; B05D 3/067; B05D 1/02

(57) ABSTRACT

There is provided a hard coat layer-forming composition that can form a surface excellent in smoothness and lipophilicity (fingerprint resistance) and that enables the formation of a smooth surface maintaining lipophilicity even by spray coating and having no uneven coating. A curable composition including: 0.01 to 10 parts by mass of a specific lipophilic highly branched polymer (a); 0.0001 to 1 part by mass of a specific silicon-containing highly branched polymer (b); 100 parts by mass of an active energy ray curable polyfunctional monomer (c); and 0.1 to 25 parts by mass of a polymerization initiator that generates radicals by an active energy ray (d). A cured film obtained from the composition. A laminate obtained by use of the composition.

### TECHNICAL FIELD

The present invention relates to a curable composition containing a silicon-containing highly branched polymer, a cured film obtained from the composition, and a laminate obtained by using the composition.

### BACKGROUND ART

Plastic materials including acrylic resins, polycarbonate resins, and ABS resins have well-balanced mechanical characteristics and excellent moldability, transparency, and lightweight properties. With these characteristics, such plastic materials are applied to casings for electronic devices and cosmetics. However, the plastic materials are inferior in some characteristics such as surface hardness, barrier properties, chemical resistance, flame resistance, and heat resistance. Among these, the surface hardness of the plastic materials is particularly lower than that of inorganic glass and other materials, and the surface is readily scratched. This feature greatly limits practical development of the plastic materials. An important technique to overcome the disadvantage is hard coating by UV curing of a polyfunctional acrylate containing a photoinitiator.

For the casings of recent electronic devices and cosmetics, glossy deep colors have been likely to be popular for improving the design. In particular, a glossy black plastic, which makes a casing look high quality, has been widely used. However, the glossy black reflects outside light. Fingerprints attached to such a casing scatter outside light and become more visible. The fingerprints ruin the image of high-quality appearance. To address this, there is an increasing demand for prevention of stains by fingerprints on a hard coat layer on the surface of a casing, or for fingerprint resistance.

The fingerprint resistance is achieved based on principles that are broadly divided into two types at the present time. One is applied to a method by using fluorine materials, silicone material, or similar materials to impart water and oil repellent properties to the surface of a hard coat layer, thereby preventing stains such as fingerprints from adhering. A water and oil repellent surface repels water and oil components contained in fingerprints to exhibit the effect of preventing fingerprint adhesion, and thus the fingerprints are easily wiped off. This is an advantage of the method. However, the attached water and oil components form small droplets with a large contact angle, and the droplets scatter light to cause a cloudy appearance, which unfortunately makes the fingerprint more visible.

Another technique is a method by imparting lipophilic properties to the surface of a hard coat layer. The surface of the lipophilic hard coat layer has high affinity for oil components contained in fingerprints, thus makes the attached oil components spread over the surface, and suppresses the formation of small droplets. Unlike the case of the water and oil repellent surface, the attached oil components consequently do not scatter light, and the method exhibits the effect of preventing fingerprints from becoming more visible. Such a method of imparting lipophilicity to the surface of a hard coat layer is exemplified by the following disclosures: a hard coat layer comprising a non-fluorine and non-silicone lipophilic antifouling agent and a non-fluorine and non-silicone leveling agents (Patent Document 1); and a hard coat layer comprising a nonionic surfactant containing a fatty acid ester (Patent Document 2).

A typical method for coating the surface of a casing with a hard coat layer is spray coating. The spray coating is a coating method by applying pressure with a gas typified by air to a coating liquid containing a hard coating material, atomizing the liquid, and spraying the atomized liquid onto a casing. The atomized liquid landed on the casing spreads over the surface, and subsequent UV curing enables the formation of a hard coat layer having excellent smoothness. To improve the wettability of the atomized liquid on a plastic casing, a method of adding a small amount of a material having a low surface energy, such as fluorine and silicone, as the leveling agent to the coating liquid to reduce the surface tension of the coating liquid is employed.

### PRIOR ART DOCUMENTS

### Patent Documents

Patent Document 1: Japanese Patent Application Publication No. 2011-73363 (JP 2011-73363 A)

Patent Document 2: Japanese Patent Application Publication No 2012-106186 (JP 2012-106186 A)

### SUMMARY OF THE INVENTION

### Problem to be Solved by the Invention

As described above, spray coating requires addition of a leveling agent to reduce the surface tension of a coating liquid. However, the non-fluorine and non-silicone leveling agent described in Patent Document 1 has poor performance of reducing the surface tension of a coating liquid, and is difficult to give a hard coat layer with a smooth surface by the spray coating. There is another problem when a fluorine or silicone leveling agent is added to a coating liquid containing a lipophilic antifouling agent. In other words, the fluorine or silicone leveling agent having water and oil repellency segregates on the surface of a hard coat layer after UV curing. This increases the contact angle of oleic acid, or impairs the lipophilicity,

In Patent Document 2, a lipophilic hard coat layer is formed by the spray coating, but the surface smoothness is not described.

That is, there is a demand for a coating liquid that does not impair the lipophilicity even by the spray coating and can form a hard coat layer with a smooth surface.

### Means for Solving the Problem

As a result of intensive studies for solving the problems, the inventors of the present invention have found that the addition of a highly branched polymer having a long-chain alkyl group and a highly branched polymer containing silicon atoms to a curable composition allows the surface of a cured film obtained from the composition to easily have excellent surface modification properties such as smoothness and lipophilicity (fingerprint resistance) and enables the formation of a smooth surface maintaining lipophilicity even by the spray coating and having no uneven coating, and have accomplished the present invention.

That is, the present invention relates to, as a first aspect, a curable composition comprising: 0.01 to 10 parts by mass of a lipophilic highly branched polymer (a); 0.0001 to 1 part by mass of a silicon-containing highly branched polymer (b); 100 parts by mass of an active energy ray curable polyfunctional monomer (c); and 0.1 to 25 parts by mass of a polymerization initiator that generates radicals by an active energy ray (d), in which the lipophilic highly branched polymer (a) is a lipophilic highly branched polymer obtained by polymerization of a monomer A having two or more radically polymerizable double bonds in a molecule and a monomer B having a C₆₋₃₀ alkyl group or a C₃₋₃₀ alicyclic group and at least one radically polymerizable double bond in a molecule, in the presence of a polymerization initiator C in an amount of 5 to 200% by mole relative to the number of moles of the monomer A, and the silicon-containing highly branched polymer (b) is a silicon-containing highly branched polymer obtained by polymerization of a monomer D having two or more radically polymerizable double bonds in a molecule, a monomer B having a polysiloxane chain and at least one radically polymerizable double bond in a molecule, and a monomer F having a C₆₋₃₀ alkyl group or a C₃₋₃₀ alicyclic group and at least one radically polymerizable double bond in a molecule, in the presence of a polymerization initiator G in an amount of 5 to 200% by mole relative to the number of moles of the monomer D.

As a second aspect, the present invention relates to the curable composition according to the first aspect, in which the monomer D is a compound having at least one of a vinyl group and a (meth)acrylic group.

As a third aspect, the present invention relates to the curable composition according to the second aspect, in which the monomer D is a divinyl compound or a di(meth)acrylate compound.

As a fourth aspect, the present invention relates to the curable composition according to any one of the first aspect to the third aspect, in which the monomer D is a compound having a C₃₋₃₀ alicyclic group.

As a fifth aspect, the present invention relates to the curable composition according to the fourth aspect, in which the monomer D is tricyclo[5.2.1.0^{2,6}]decanedimethanol di(meth)acrylate.

As a sixth aspect, the present invention relates to the curable composition according to any one of the first aspect to the fifth aspect, in which the monomer E is a compound having at least one of a vinyl group and a (meth)acrylic group.

As a seventh aspect, the present invention relates to the curable composition according to the sixth aspect, in which the monomer E is a compound of Formula [2]:

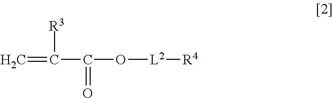

(where R³ is a hydrogen atom or a methyl group; R⁴ is a polysiloxane chain bonded to L² by a silicon atom; and L² is a C₁₋₆ alkylene group).

As an eighth aspect, the present invention relates to the curable composition according to the seventh aspect, in which the monomer E is a compound of Formula [3]:

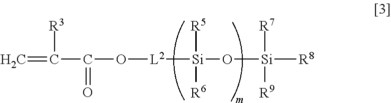

(where each of R³ and L² is the same as defined in Formula [2]; each of R⁵ to R⁹ is independently a C₁₋₆ alkyl group; and m is an integer of 1 to 200).

As a ninth aspect, the present invention relates to the curable composition according to any one of the first aspect to the eighth aspect, in which the monomer F is a compound having at least one of a vinyl group and a (meth)acrylic group.

As a tenth aspect, the present invention relates to the curable composition according to the ninth aspect, in which the monomer F is a compound of Formula [4]:

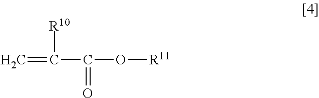

(where R¹⁰ is a hydrogen atom or a methyl group; and R¹¹ is a C₆₋₃₀ alkyl group or a C₃₋₃₀ alicyclic group).

As an eleventh aspect, the present invention relates to the curable composition according to any one of the second aspect to the tenth aspect, in which the polymerization initiator G is an azo polymerization initiator.

As a twelfth aspect, the present invention relates to the curable composition according to any one of the first aspect to the eleventh aspect, in which the silicon-containing highly branched polymer (b) is a silicon-containing highly branched polymer obtained by using the monomer E in an amount of 0.01 to 10% by mole and the monomer F in an amount of 10 to 300% by mole relative to the number of moles of the monomer D.

As a thirteenth aspect, the present invention relates to the curable composition according to any one of the first aspect to the twelfth aspect, in which the monomer A is a compound having at least one of a vinyl group and a (meth)acrylic group.

As a fourteenth aspect, the present invention relates to the curable composition according to the thirteenth aspect, in which the monomer A is a divinyl compound or a di(meth)acrylate compound.

As a fifteenth aspect, the present invention relates to the curable composition according to any one of the first aspect to the fourteenth aspect, in which the monomer A is a compound having a C₃₋₃₀ alicyclic group.

As a sixteenth aspect, the present invention relates to the curable composition according to the fifteenth aspect, in which the monomer A is tricyclo[5.2.1.0^{2,6}]decanedimethanol di(meth)acrylate.

As a seventeenth aspect, the present invention relates to the curable composition according to any one of the first aspect to the sixteenth aspect, in which the monomer B is a compound having at least one of a vinyl group and a (meth)acrylic group.

As an eighteenth aspect, the present invention relates to the curable composition according to the seventeenth aspect, in which the monomer B is a compound of Formula [1]:

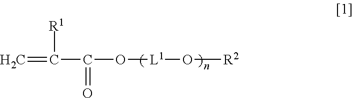

(where R¹ is a hydrogen atom or a methyl group; R² is a C₆₋₃₀ alkyl group or a C₃₋₃₀ alicyclic group; L¹ is a C₂₋₆ alkylene group; and n is an integer of 0 to 30).

As a nineteenth aspect, the present invention relates to the curable composition according to the eighteenth aspect, in which n is 0.

As a twentieth aspect, the present invention relates to the curable composition according to any one of the thirteenth aspect to the nineteenth aspect, in which the polymerization initiator C is an azo polymerization initiator.

As a twenty-first aspect, the present invention relates to the curable composition according to any one of the first aspect to the twentieth aspect, in which the lipophilic highly branched polymer (a) is a lipophilic highly branched polymer obtained by using the monomer B in an amount of 5 to 300% by mole relative to the number of moles of the monomer A.

As a twenty-second aspect, the present invention relates to the curable composition according to any one of the first aspect to the twenty-first aspect, in which the polyfunctional monomer (c) is at least one selected from the group consisting of polyfunctional (meth)acrylate compounds and polyfunctional urethane (meth)acrylate compounds.

As a twenty-third aspect, the present invention relates to the curable composition according to any one of the first aspect to the twenty-second aspect, in which the polymerization initiator (d) is an alkylphenone compound.

As a twenty-fourth aspect, the present invention relates to the curable composition according to any one of the first aspect to the twenty-third aspect, further comprising a solvent (e).

As a twenty-fifth aspect, the present invention relates to a cured film obtained from the curable composition as described in any one of the first aspect to the twenty-fourth aspect.

As a twenty-sixth aspect, the present invention relates to a laminate comprising: a hard coat layer on at least one side of a substrate, in which the hard coat layer is formed by the steps of applying the curable composition as described in any one of the first aspect to the twenty-fourth aspect onto the substrate to form a coating film and irradiating the coating film with ultraviolet rays to cure the coating film.

As a twenty-seventh aspect, the present invention relates to the laminate according to the twenty-sixth aspect, in which the application of the curable composition is performed by spray-coating in the step of forming the coating film.

As a twenty-eighth aspect, the present invention relates to the laminate according to the twenty-seventh aspect, in which the hard coat layer has a film thickness of 1 to 50 μm.

### Effects of the Invention

To the lipophilic highly branched polymer and the silicon-containing highly branched polymer contained in the curable composition of the present invention, branched structures are intentionally introduced. The polymer molecules are thus entangled in a smaller degree than those of linear polymer molecules, and the polymers exhibit a fine particle-like behavior and have high solubility in organic solvents and high dispersivity in resins. These characteristics prevent the highly branched polymers from aggregating in a resin that is the matrix, readily transfer the polymers to the surface, and readily activate the resin surface. Thus, the addition of the lipophilic highly branched polymer and the silicon-containing highly branched polymer to a curable composition allows a cured film obtained from the composition to readily have a surface with excellent surface modification properties such as smoothness and lipophilicity (fingerprint resistance).

The curable composition of the present invention does not impair the lipophilicity even by spray coating and can form a smooth surface without uneven coating.

The cured film and the hard coat layer of the laminate of the present invention have smoothness and lipophilicity (fingerprint resistance).

### BRIEF DESCRIPTION OF THE DRAWINGS

FIG. 1 is a view showing a ¹³C NMR spectrum of a lipophilic highly branched polymer obtained in Reference Example 1.

FIG. 2 is a view showing a ¹³C NMR spectrum of a silicon-containing highly branched polymer obtained in Reference Example 2.

FIG. 3 is a view showing a ¹³C NMR spectrum of a silicon-containing highly branched polymer obtained in Reference Example 3.

### MODES FOR CARRYING OUT THE INVENTION

<Curable Composition>

The present invention relates to a curable composition comprising a lipophilic highly branched polymer (a), a silicon-containing highly branched polymer (b), an active energy ray curable polyfunctional monomer (c), and a polymerization initiator (d) to generate radicals by active energy rays.

[Lipophilic Highly Branched Polymer (a)]

A lipophilic highly branched polymer (a) as component is obtained by polymerization of a monomer A having two or more radically polymerizable double bonds in the molecule and a monomer B having a C₆₋₃₀ alkyl group or a C₃₋₃₀ alicyclic group and at least one radically polymerizable double bond in the molecule in the presence of a polymerization initiator C in an amount of 5 to 200% by mole relative to the number of moles of the monomer A.

The lipophilic highly branched polymer may be copolymerized with other monomers different form the monomer A, the monomer B, or the monomer E, as necessary, as long as the effect of the present invention is not impaired.

The lipophilic highly branched polymer is what is called an initiator-fragment incorporation radical polymerization (IFIRP) highly branched polymer and has, at a terminal, a fragment of the polymerization initiator C used for the polymerization.

[Monomer A]

In the present invention, the monomer A having two or more radically polymerizable double bonds in the molecule preferably has at least one of a vinyl group and a (meth)acrylic group, and is particularly preferably a divinyl compound or a di(meth)acrylate compound.

In the present invention, the (meth)acrylate compound means both an acrylate compound and a methacrylate compound. For example, (meth)acrylic acid means acrylic acid and methacrylic acid.

Such a monomer A is exemplified by the following organic compounds (A1) to (A7).
(A1) Vinyl hydrocarbons:
(A1-1) Aliphatic vinyl hydrocarbons such as isoprene, butadiene, 3-methyl-1,2-butadiene, 2,3-dimethyl-1,3-butadiene, 1,2-polybutadiene, pentadiene, hexadiene, and octadiene
(A1-2) Alicyclic vinyl hydrocarbons such as cyclopentadiene, cyclohexadiene, cyclooctadiene, and norbornadiene
(A1-3) Aromatic vinyl hydrocarbons such as divinylbenzene, divinyltoluene, divinylxylene, trivinylbenzene, divinylbiphenyl, divinylnaphthalene, divinylfluorene, divinylcarbazole, and divinylpyridine
(A2) Vinyl esters, allyl esters, vinyl ethers, allyl ethers, and vinyl ketones:
(A2-1) Vinyl esters such as divinyl adipate, divinyl maleate, divinyl phthalate, divinyl isophthalate, divinyl itaconate, and vinyl(meth)acrylate
(A2-2) Allyl esters such as diallyl maleate, diallyl phthalate, diallyl isophthalate, diallyl adipate, and allyl(meth)acrylate
(A2-3) Vinyl ethers such as divinyl ether, diethylene glycol divinyl ether, and triethylene glycol divinyl ether
(A2-4) Allyl ethers such as diallyl ether, di(allyloxy)ethane, tri(allyloxy)ethane, tetra(allyloxy)ethane, tetra(allyloxy)propane, tetra(allyloxy)butane, and tetra(methallyloxy)ethane
(A2-5) Vinyl ketones such as divinyl ketone and diallyl ketone
(A3) (Meth)acrylic acid esters:
such as ethylene glycol di(meth)acrylate, triethylene glycol di(meth)acrylate, propylene glycol di(meth)acrylate, neopentyl glycol di(meth)acrylate, trimethylolpropane tri(meth)acrylate, ditrimethylolpropane tetra(meth)acrylate, glycerol tri(meth)acrylate, pentaerythritol tetra(meth)acrylate, alkoxytitanium tri(meth)acrylate, 1,6-hexanediol di(meth)acrylate, 2-methyl-1,8-octanediol di(meth)acrylate, 1,9-nonanediol di(meth)acrylate, 1,10-decanediol di(meth)acrylate, tricyclo[5.2.1.0^{2,6}]decanedimethanol di(meth)acrylate, dioxane glycol di(meth)acrylate, 2-hydroxy-1-acryloyloxy-3-methacryloyloxypropane, 2-hydroxy-1,3-di(meth)acryloyloxypropane, 9,9-bis[4-(2-(meth)acryloyloxyethoxy)phenyl]fluorene, undecyleneoxyethylene glycol di(meth)acrylate, bis[4-(meth)acryloylthiophenyl]sulfide, bis[2-(meth)acryloylthioethyl]sulfide, 1,3-adamantanediol di(meth)acrylate, 1,3-adamantanedimethanol di(meth)acrylate, aromatic urethane di(meth)acrylate, and aliphatic urethane di(meth)acrylate
(A4) Vinyl compounds having a poly(alkylene glycol) chain: such as poly(ethylene glycol) (a molecular weight of 300) di(meth)acrylate and poly(propylene glycol) (a molecular weight of 500) di(meth)acrylate
(A5) Nitrogen-containing vinyl compounds: such as diallylamine, diallyl isocyanurate, diallyl cyanurate, methylenebis(meth)acrylamide, and bismaleimide
(A6) Silicon-containing vinyl compounds:
such as dimethyldivinylsilane, divinyl(methyl)(phenyl)silane, diphenyldivinylsilane, 1,3-divinyl-1,1,3,3-tetrametbyldisilazane, 1,3-divinyl-1,1,3,3-tetraphenyldisilazane, and diethoxydivinylsilane
(A7) Fluorine-containing vinyl compounds:
such as 1,4-divinylperfluorobutane, 1,4-divinyloctafluorobutane, 1,6-divinylperfluorohexane, 1,6-divinyldodecafluorohexane, 1,8-divinylperfluorooctane, and 1,8-divinylhexadecafluorooctane

Among them, preferred monomers are the aromatic vinyl hydrocarbons of the group (A1-3), the vinyl esters, the allyl esters, the vinyl ethers, the allyl ethers, and the vinyl ketones of the group (A2), the (meth)acrylic acid esters of the group (A3), the vinyl compounds having a poly(alkylene glycol) chain of the group (A4), and the nitrogen-containing vinyl compounds of the group (A5). Particularly preferred monomers are divinylbenzene in the group (A1-3), diallyl phthalate in the group (A2-2), ethylene glycol di(meth)acrylate, 1,3-adamantanedimethanol di(meth)acrylate, tricyclo[5.2.1.0^{2,6}]decanedimethanol di(meth)acrylate, 2-hydroxy-1,3-di(meth)acryloyloxypropane, and aliphatic urethane di(meth)acrylate in the group (A3), and methylenebis(meth)acrylamide in the group (A5).

Among them, divinylbenzene, ethylene glycol di(meth)acrylate, tricyclo[5.2.1.0^{2,6}]decanedimethanol di(meth)acrylate, and 2-hydroxy-1,3-di(meth)acryloyloxypropane are preferred, and tricyclo[5.2.1.0^{2,6}]decanedimethanol di(meth)acrylate and 2-hydroxy-1,3-di(meth)acryloyloxypropane are particularly preferred.

[Monomer B]

In the present invention, the monomer B having a C₆₋₃₀ alkyl group or a C₃₋₃₀ alicyclic group and at least one radically polymerizable double bond in the molecule preferably has at least one of a vinyl group and a (meth)acrylic group, and is particularly preferably the compound of Formula [1].

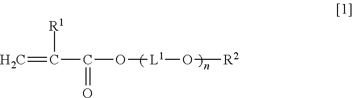

(In the formula, R¹ is a hydrogen atom or a methyl group; R² is a C₆₋₃₀ alkyl group or a C₃₋₃₀ alicyclic group; L¹ is a C₂₋₆ alkylene group; and n is an integer of 0 to 30)

Examples of the C₆₋₃₀ alkyl group as R² include a hexyl group, an ethylhexyl group, a 3,5,5-trimethylhexyl group, a heptyl group, an octyl group, a 2-octyl group, an isooctyl group, a nonyl group, a decyl group, an isodecyl group, an undecyl group, a lauryl group, a tridecyl group, a myristyl group, a palmityl group, a stearyl group, an isostearyl group, an arachyl group, a behenyl group, a lignoceryl group, a cerotoyl group, a montanyl group, and a melissyl group.

Among these, the alkyl group preferably has 10 to 30 carbon atoms and more preferably 12 to 24 carbon atoms in view of the surface modification effect. The alkyl group as R² may be a linear group or a branched group, and either group can impart excellent surface modification properties such as lipophilicity (fingerprint resistance) to a coating film obtained from the curable composition of the present invention without deteriorating the original transparency of a resin. R² is preferably a linear alkyl group because it can impart better lipophilicity (fingerprint resistance) to a coating film.

Examples of the C₃₋₃₀ alicyclic group as R² include a cyclopropyl group, a cyclobutyl group, a cyclopentyl group, a cyclohexyl group, a 4-tert-butylcyclohexyl group, an isobornyl group, a norbornenyl group, a menthyl group, an adamantyl group, and a tricyclo[5.2.1.0^{2,6}]decanyl group.

Among these, C₃₋₁₄ alicyclic groups are preferred, and C₆₋₁₂ alicyclic groups are more preferred in view of the surface modification effect.

Examples of the C₂₋₆ alkylene group as L¹ include an ethylene group, a trimethylene group, a methylethylene group, a tetramethylene group, a 1-methyltrimethylene group, a pentamethylene group, a 2,2-dimethyltrimethylene group, and a hexamethylene group.

Among these, an ethylene group is preferred in view of the surface modification effect.

n is preferably 0 in view of the surface modification effect.

Examples of such a monomer B include hexyl(meth)acrylate, ethylhexyl(meth)acrylate, 3,5,5-trimethylhexyl(meth)acrylate, heptyl(meth)acrylate, octyl(meth)acrylate, 2-octyl(meth)acrylate, isooctyl(meth)acrylate, nonyl(meth)acrylate, decyl(meth)acrylate, isodecyl(meth)acrylate, undecyl(meth)acrylate, lauryl(meth)acrylate, tridecyl(meth)acrylate, palmityl(meth)acrylate, stearyl(meth)acrylate, isostearyl(meth)acrylate, behenyl(meth)acrylate, cyclopropyl(meth)acrylate, cyclobutyl(meth)acrylate, cyclopentyl(meth)acrylate, cyclohexyl(meth)acrylate, 4-tert-butyl cyclohexyl(meth)acrylate, isobornyl(meth)acrylate, norbornene(meth)acrylate, menthyl(meth)acrylate, adamantane(meth)acrylate, tricyclo[5.2.1.0^{2,6}]decane(meth)acrylate, 2-hexyloxyethyl(meth)acrylate, 2-lauryloxyethyl(meth)acrylate, 2-stearyloxyethyl(meth)acrylate, 2-cyclohexyloxyethyl(meth)acrylate, trimethylene glycol monolauryl ether(meth)acrylate, tetramethylene glycol monolauryl ether(meth)acrylate, hexamethylene glycol monolauryl ether(meth)acrylate, diethylene glycol monostearyl ether(meth)acrylate, triethylene glycol monostearyl ether(meth)acrylate, tetraethylene glycol monolauryl ether(meth)acrylate, tetraethylene glycol monostearyl ether(meth)acrylate, and hexaethylene glycol monostearyl ether(meth)acrylate. These monomers B may be used singly or in combination of two or more of them.

For the copolymerization of the monomer A and the monomer B in the present invention, the ratio of the monomer B is preferably 5 to 300% by mole, more preferably 10 to 150% by mole relative to the number of moles of the monomer A in view of the reactivity and the surface modification effect.

(Other Monomers)

In the present invention, other monomers different form the monomer A, the monomer B, or the monomer E may be any monomer having a radically polymerizable double bond in the molecule and is preferably a vinyl compound or a (meth)acrylate compound.

Such a monomer is exemplified by the following compounds (1) to (3):
(1) fluorine-containing monomers such as 2-(trifluoromethyl)acrylic acid, 2,2,2-trifluoroethyl(meth)acrylate, 2,2,3,3-tetrafluoropropyl(meth)acrylate, 2,2,3,3,3-pentafluoropropyl(meth)acrylate, 1H-1-(trifluoromethyl)trifluoroethyl(meth)acrylate, 1H,1H,3H-hexafluorobutyl(meth)acrylate, 1H,1H,5H-octafluoropentyl(meth)acrylate, 2-(perfluorobutyl)ethyl(meth)acrylate, and 3-(perfluorobutyl)-2-hydroxypropyl(meth)acrylate;
(2) silicon-containing monomers such as 3-(triethoxysilyl)propyl(meth)acrylate, 3-(trimethoxysilyl)propyl(meth)acrylate, 3-(dimethoxy(methyl)silyl)propyl(meth)acrylate, trimethoxyvinylsilane, triethoxyvinylsilane, tris(2-methoxyethoxy)vinylsilane, dimethoxy(methyl)(vinyl)silane, and 4-(trimethoxysilyl)styrene; and
(3) alkylene glycol monomers such as 2-methoxyethyl(meth)acrylate, polyethylene glycol)monomethyl ether(meth)acrylate (the number of ethylene glycol units is 2, 3, 4, 5, 6, 7, 8, 9, 10, 11, 12, 13, 14, 15, 16, 17, 18, 19, 20, 21, 22, and 23, for example), poly(propylene glycol)monomethyl ether(meth)acrylate (the number of propylene glycol units is 2, 3, 4, 5, 6, 7, 8, 9, 10, 11, 12, 13, 14, 15, 16, 17, 18, 19, 20, 21, 22, and 23, for example).

(Polymerization Initiator C)

In the present invention, the polymerization initiator C is preferably an azo polymerization initiator. The azo polymerization initiator can be exemplified by the following compounds (1) to (5).

### (1) Azonitrile Compounds:

such as 2,2′-azobisisobutyronitrile, 2,2′-azobis(2-methylbutyronitrile), 2,2′-azobis(2,4-dimethylvaleronitrile), 1,1′-azobis(1-cyclohexanecarbonitrile), 2,2′-azobis(4-methoxy-2,4-dimethylvaleronitrile), and 2-(carbamoylazo)isobutyronitrile;

### (2) Azoamide Compounds:

such as 2,2′-azobis{2-methyl-N-[1,1-bis(hydroxymethyl)-2-hydroxyethyl]propionamide}, 2,2′-azobis{2-methyl-N-[2-(1-hydroxybutyl)]propionamide}, 2,2′-azobis[2-methyl-N-(2-hydroxyethyl)propionamide], 2,2′-azobis[N-(2-propenyl)-2-methylpropionamide], 2,2′-azobis(N-butyl-2-methylpropionamide), and 2,2′-azobis(N-cyclohexyl-2-methylpropionamide);

### (3) Cyclic Azoamidine Compounds:

such as 2,2′-azobis[2-(2-imidazolin-2-yl)propane]dihydrochloride, 2,2′-azobis[2-(2-imidazolin-2-yl)propane]disulfate dihydrate, 2,2′-azobis[2-[1-(2-hydroxyethyl)-2-imidazolin-2-yl]propane]dihydrochloride, 2,2′-azobis[2-(2-imidazolin-2-yl)propane], and 2,2′-azobis(1-imino-1-pyrrolidino-2-methylpropane)dihydrochloride;

### (4) Azoamidine Compounds:

such as 2,2′-azobis(2-methylpropionamidine)dihydrochloride and 2,2′-azobis[N-(2-carboxyethyl)-2-methylpropionamidine]tetrahydrate;

### (5) Others:

such as 2,2′-azobis(methyl isobutyrate), 4,4′-azobis(4-cyanopentanoic acid), 2,2′-azobis(2,4,4-trimethylpentane), 1,1′-azobis(1-acetoxy-1-phenylethane), 1,1′-azobis(methyl 1-cyclohexanecarboxylate), 4,4′-azobis(2-(perfluoromethyl)ethyl 4-cyanopentanoate), 4,4′-azobis(2-(perfluorobutyl)ethyl 4-cyanopentanoate), and 4,4′-azobis(2-(perfluorohexyl)ethyl 4-cyanopentanoate).

Among the above azo polymerization initiators, compounds having a substituent with a comparatively low polarity are preferred in view of the surface energy of a lipophilic highly branched polymer to be obtained, and 2,2′-azobis(methyl isobutyrate) or 2,2′-azobis(2,4-dimethylvaleronitrile) are particularly preferred.

The polymerization initiator C is used in an amount of 5 to 200% by mole, preferably 20 to 200% by mole, and more preferably 20 to 100% by mole relative to the number of moles of the monomer A.

<Method for Producing Lipophilic Highly Branched Polymer>

The lipophilic highly branched polymer (a) as component of the present invention is obtained by polymerization of the monomer A, the monomer B, and, if desired, other monomers in the presence of the polymerization initiator C in a predetermined amount relative to the amount of the monomer A. The polymerization method is exemplified by known methods such as solution polymerization, dispersion polymerization, precipitation polymerization, and bulk polymerization. Among them, the solution polymerization or the precipitation polymerization is preferred. To control the molecular weight, in particular, the solution polymerization in an organic solvent is preferred.

Examples of the organic solvent used for the polymerization include aromatic hydrocarbons such as benzene, toluene, xylene, ethylbenzene, and tetralin; aliphatic or alicyclic hydrocarbons such as n-hexane, n-heptane, mineral spirits, and cyclohexane; halides such as methyl chloride, methyl bromide, methyl iodide, methylene dichloride, chloroform, carbon tetrachloride, trichloroethylene, perchloroethylene, and o-dichlorobenzene; esters or ester ethers such as ethyl acetate, butyl acetate, isobutyl acetate, methoxybutyl acetate, methyl cellosolve acetate, ethyl cellosolve acetate, and propylene glycol monomethyl ether acetate (PGMEA); ethers such as diethyl ether, tetrahydrofuran (THF), 1,4-dioxane, methyl cellosolve, ethyl cellosolve, butyl cellosolve, and propylene glycol monomethyl ether (PGME); ketones such as acetone, methyl ethyl ketone (MEK), methyl isobutyl ketone (MIBK), di-n-butyl ketone, and cyclohexanone; alcohols such as methanol, ethanol, n-propanol, isopropanol, n-butanol, isobutanol, tert-butanol, 2-ethylhexyl alcohol, benzyl alcohol, and ethylene glycol; amides such as N,N-dimethylformamide (DMF), N,N-dimethylacetamide, and N-methyl-2-pyrrolidone (NMP); sulfoxides such as dimethyl sulfoxide (DMSO), and these solvents may be used as a mixture of two or more of them.

Among them, preferred solvents are the aromatic hydrocarbons, the halides, the esters, the ethers, the ketones, the alcohols, and the amides. Particularly preferred solvents are exemplified by benzene, toluene, xylene, o-dichlorobenzene, ethyl acetate, butyl acetate, propylene glycol monomethyl ether acetate (PGMEA), propylene glycol monomethyl ether (PGME), tetrahydrofuran (THF), 1,4-dioxane, methyl ethyl ketone (MEK), methyl isobutyl ketone (MIBK), methanol, ethanol, n-propanol, isopropanol, n-butanol, isobutanol, tert-butanol, N,N-dimethylformamide (DMF), N,N-dimethylacetamide, and N-methyl-2-pyrrolidone (NMP).

For the polymerization in the presence of an organic solvent, the mass of the organic solvent is typically 5 to 120 parts by mass and preferably 10 to 110 parts by mass relative to 1 part by mass of the monomer A.

The polymerization is carried out under normal pressure, under pressure in a closed system, or under reduced pressure, and is preferably carried out under normal pressure in view of a simple apparatus and a simple operation. In addition, the polymerization is preferably carried out under an inert gas atmosphere such as nitrogen.

The polymerization is carried out at any temperature that is not higher than the boiling point of a reaction mixture. The temperature is preferably 50 to 200° C., more preferably 80 to 150° C., and even more preferably 80 to 130° C. in view of the polymerization efficiency and the molecular weight control.

The reaction time varies with the reaction temperature, the types and ratio of the monomer A, the monomer B, other monomers, and the polymerization initiator C, the type of the polymerization solvent, and other conditions, and thus cannot be generally specified, but is preferably 30 to 720 minutes and more preferably 40 to 540 minutes.

After the completion of the polymerization, the obtained lipophilic highly branched polymer is collected by any method and is subjected to aftertreatments such as washing, as necessary. The method for collecting the polymer from the reaction solution is exemplified by reprecipitation.

In the present invention, the weight average molecular weight (Mw) of the lipophilic highly branched polymer (a) as component measured by gel permeation chromatography in terms of polystyrene is preferably 1,000 to 200,000, more preferably 2,000 to 100,000, and most preferably 5,000 to 60,000.

[Silicon-Containing Highly Branched Polymer (b)]

A silicon-containing highly branched polymer (b) as component is obtained by polymerization of a monomer D having two or more radically polymerizable double bonds in the molecule, a monomer E having a polysiloxane chain and at least one radically polymerizable double bond in the molecule, and a monomer F having a C₆₋₃₀ alkyl group or a C₃₋₃₀ alicyclic group and at least one radically polymerizable double bond in the molecule, in the presence of a polymerization initiator G in an amount of 5 to 200% by mole relative to the number of moles of the monomer D.

The silicon-containing highly branched polymer may be copolymerized with other monomers different from the monomer D, the monomer E, or the monomer F, as necessary, as long as the effect of the present invention is not impaired.

The silicon-containing highly branched polymer is what is called an initiator-fragment incorporation radical polymerization (IFIRP) highly branched polymer and has a fragment of the polymerization initiator G used for the polymerization at a terminal.

(Monomer D)

In the present invention, as the monomer D having two or more radically polymerizable double bonds in the molecule, the monomers described in [Lipophilic Highly Branched Polymer (a)] (Monomer A), may be used.

(Monomer E)

In the present invention, the monomer E having a polysiloxane chain and at least one radically polymerizable double bond in the molecule preferably has at least one of a vinyl group and a (meth)acrylic group, is particularly preferably the compound of Formula [2] below, and is more preferably the compound of Formula [3] below.

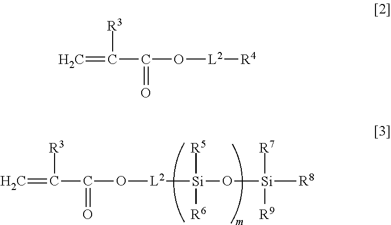

(In the formulae, R³ is a hydrogen atom or a methyl group; R⁴ is a polysiloxane chain bonded to L² by a silicon atom; each of R⁵ to R⁹ is independently a C₁₋₆ alkyl group; L² is a C₁₋₆ alkylene group; and m is an integer of 1 to 200)

Examples of the C₁₋₆ alkylene group as L² include a methylene group, an ethylene group, a trimethylene group, a methylethylene group, a tetramethylene group, a 1-methyltrimethylene group, a pentamethylene group, a 2,2-dimethyltrimethylene group, and a hexamethylene group.

Among these, a trimethylene group is preferred.

Examples of the C₁₋₆ alkyl group as R⁵ to R⁹ include a methyl group, an ethyl group, an n-propyl group, an isopropyl group, an n-butyl group, an isobutyl group, a sec-butyl group, a tea-butyl group, an n-pentyl group, an isopentyl group, a neopentyl group, an n-hexyl group, and a cyclohexyl group.

Among these, a methyl group, an ethyl group, and an n-butyl group are preferred.

In view of the surface modification effect, m is preferably 10 to 100.

Examples of such a monomer E include α-butyl-ω-(3-(meth)acryloyloxyethyl)poly(dimethylsiloxane), α-methyl-ω-(3-(meth)acryloyloxypropyl)poly(dimethylsiloxane), α-butyl-ω-(3-(meth)acryloyloxypropyl)poly(dimethylsiloxane), and α-butyl-ω-(3-(meth)acryloyloxyhexyl)poly(dimethylsiloxane). These monomers E may be used singly or in combination of two or more of them.

(Monomer F)

In the present invention, the monomer F having a C₆₋₃₀ alkyl group or a C₃₋₃₀ alicyclic group and at least one radically polymerizable double bond in the molecule preferably has at least one of a vinyl group and a (meth)acrylic group and is particularly preferably the compound of Formula [4] below.

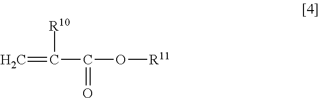

(In the formula, R¹⁰ is a hydrogen atom or a methyl group; and R¹¹ is a C₆₋₃₀ alkyl group or a C₃₋₃₀ alicyclic group)

Examples of the C₆₋₃₀ alkyl group as R¹¹ include a hexyl group, an ethylhexyl group, a 3,5,5-trimethylhexyl group, a heptyl group, an octyl group, a 2-octyl group, an isooctyl group, a nonyl group, a decyl group, an isodecyl group, an undecyl group, a lauryl group, a tridecyl group, a myristyl group, a palmityl group, a stearyl group, an isostearyl group, an arachyl group, a behenyl group, a lignoceryl group, a cerotoyl group, a montanyl group, and a melissyl group.

Among these, the alkyl group preferably has 10 to 30 carbon atoms and more preferably 12 to 24 carbon atoms in view of the surface modification effect.

Examples of the C₃₋₃₀ alicyclic group as R¹¹ include a cyclopropyl group, a cyclobutyl group, a cyclopentyl group, a cyclohexyl group, a 4-tert-butylcyclohexyl group, an isobornyl group, a norbornenyl group, a menthyl group, an adamantyl group, and a tricyclo[5.2.1.0^{2,6}]decanyl group.

Among these, C₃₋₁₄ alicyclic groups are preferred, and C₆₋₁₂ alicyclic groups are more preferred in view of the surface modification effect.

Examples of such a monomer F include hexyl(meth)acrylate, ethylhexyl (meth)acrylate, 3,5,5-trimethylhexyl(meth)acrylate, heptyl(meth)acrylate, octyl(meth)acrylate,

2-octyl(meth)acrylate, isooctyl(meth)acrylate, nonyl(meth)acrylate, decyl(meth)acrylate, isodecyl(meth)acrylate, undecyl(meth)acrylate, lauryl(meth)acrylate, tridecyl(meth)acrylate, palmityl(meth)acrylate, stearyl(meth)acrylate, isostearyl(meth)acrylate, behenyl(meth)acrylate, cyclopropyl(meth)acrylate, cyclobutyl(meth)acrylate, cyclopentyl(meth)acrylate, cyclohexyl(meth)acrylate, 4-tert-butylcyclohexyl(meth)acrylate, isobornyl(meth)acrylate, norbornene(meth)acrylate, menthyl(meth)acrylate, adamantane(meth)acrylate, and tricyclo[5.2.1.0^{2,6}]decane(meth)acrylate. These monomers F may be used singly or in combination of two or more of them.

For the copolymerization of the monomer D, the monomer E, and the monomer F in the present invention, the ratio of the monomer E is preferably 0.01 to 10% by mole, more preferably 0.1 to 10% by mole, and even more preferably 0.1 to 5% by mole relative to the number of moles of the monomer D in view of the reactivity and the surface modification effect. The ratio of the monomer F is 10 to 300% by mole, preferably 20 to 150% by mole, and more preferably 20 to 100% by mole.

(Other Monomers)

In the present invention, as other monomers different from the monomer D, the monomer E, or the monomer F, the monomers described in [Lipophilic Highly Branched Polymer (a)] (Other Monomers), may be used.

(Polymerization Initiator G)

In the present invention, as the polymerization initiator G, the polymerization initiators described in [Lipophilic Highly Branched Polymer (a)] (Polymerization Initiator C), may be used.

Among the above azo polymerization initiators, compounds having a substituent with a comparatively low polarity are preferred in view of the surface energy of a silicon-containing highly branched polymer to be obtained, and 2,2′-azobis(methyl isobutyrate) or 2,2′-azobis(2,4-dimethylvaleronitrile) are particularly preferred.

The polymerization initiator G is used in an amount of 5 to 200% by mole, preferably 20 to 200% by mole, and more preferably 20 to 100% by mole relative to the number of moles of the monomer D.

(Method for Producing Silicon-Containing Highly Branched Polymer)

In the present invention, the silicon-containing highly branched polymer (b) as component can be produced by the production method described in [Lipophilic Highly Branched Polymer (a)] (Method for Producing Lipophilic Highly Branched Polymer).

The weight average molecular weight (Mw) of the silicon-containing highly branched polymer (b) as component measured by gel permeation chromatography in terms of polystyrene is 1,000 to 400,000 and preferably 2,000 to 200,000.

[Active Energy Ray Curable Polyfunctional Monomer (c)]

Examples of the active energy ray curable polyfunctional monomer (c) as component include polyfunctional monomers containing two or more (meth)acryloyl groups, such as urethane acrylic monomers, epoxy acrylic monomers, and various (meth)acrylate monomers.

The monomer is preferably at least one monomer selected from the group consisting of polyfunctional (meth)acrylate compounds and polyfunctional urethane (meth)acrylate compounds.

Examples of such an active energy ray curable polyfunctional monomer include hexanediol di(meth)acrylate, neopentyl glycol di(meth)acrylate, triethylene glycol di(meth)acrylate, poly(ethylene glycol)di(meth)acrylate, poly(propylene glycol)di(meth)acrylate, pentaerythritol di(meth)acrylate monostearate, ethoxylated bisphenol A (meth)acrylate, ethoxylated bisphenol F (meth)acrylate, tricyclo[5.2.1.0^{2,6}]decanedimethanol di(meth)acrylate, tris(hydroxyethyl)isocyanurate di(meth)acrylate, trimethylolpropane tri(meth)acrylate, ethoxylated trimethylolpropane tri(meth)acrylate, propoxylated trimethylolpropane tri(meth)acrylate, pentaerythritol tri(meth)acrylate, tris((meth)acryloyloxyethyl)phosphate, tris(hydroxyethyl)isocyanurate tri(meth)acrylate, modified ε-caprolactone tri(meth)acrylate, trimethylolpropane ethoxy tri(meth)acrylate, propoxylated glycerin tris(meth)acrylate, pentaerythritol tetra(meth)acrylate, ethoxylated pentaerythritol tetra(meth)acrylate, ditrimethylolpropane tetra(meth)acrylate, dipentaerythritol hexa(meth)acrylate, dipentaerythritol monohydroxy penta(meth)acrylate, urethane(meth)acrylate, epoxy(meth)acrylate, polyester (meth)acrylate, and unsaturated polyester.

In the curable composition of the present invention, the formulation amount of the lipophilic highly branched polymer (a) and the active energy ray curable polyfunctional monomer (c) is as shown below. In other words, the lipophilic highly branched polymer (a) is used in an amount of 0.01 to 10 parts by mass, preferably 0.1 to 10 parts by mass, and particularly preferably 0.1 to 5 parts by mass relative to 100 parts by mass of the polyfunctional monomer (c).

The formulation amount of the silicon-containing highly branched polymer (b) and the active energy ray curable polyfunctional monomer (c) is as shown below. In other words, the silicon-containing highly branched polymer (b) is used in an amount of 0.0001 to 1 part by mass, preferably 0.001 to 1 part by mass, and particularly preferably 0.001 to 0.5 part by mass relative to 100 parts by mass of the polyfunctional monomer (c).

[Polymerization Initiator Generating Radicals by Active Energy Rays (d)]

Examples of the polymerization initiator generating radicals by active energy rays (d) as component include alkylphenones, benzophenones, ketals, anthraquinones, thioxanthones, azo compounds, peroxides, 2,3-dialkyldiones, disulfides, thiurams, and fluoroamines. Among them, the alkylphenones, particularly, α-hydroxyalkylphenones are preferably used. More specific examples include 1-hydroxycyclohexyl phenyl ketone, 2-hydroxy-1-{4-[4-(2-hydroxy-2-methylpropionyl)benzyl]phenyl}-2-methylpropan-1-one, 2-methyl-1-[4-(methylthio)phenyl]-2-morpholinopropan-1-one, benzyl dimethyl ketone, 1-(4-dodecylphenyl)-2-hydroxy-2-methylpropan-1-one, 2-hydroxy-2-methyl-1-phenylpropan-1-one, 1-(4-isopropylphenyl)-2-hydroxy-2-methylpropan-1-one, 2,2-dimethoxy-1,2-diphenylethan-1-one, 1-[4-(2-hydroxyethoxy)phenyl]-2-hydroxy-2-methyl-1-propan-1-one, 2-benzyl-2-dimethylamino-1-(4-morpholinophenyl)-1-butanone, 2-dimethylamino-2-[(4-methylphenyl)methyl]-1-[4-(4-morpholinyl)phenyl]-1-butanone, 2,4,6-trimethylbenzoyldiphenylphosphine oxide, bis(2,4,6-trimethylbenzoyl)(phenyl)phosphine oxide, 2-benzoyloxyimino-1-[4-(phenylthio)phenyl]octan-1-one, 1-{1-[9-ethyl-6-(2-methylbenzoyl)-9H-carbazol-3-yl]ethylideneaminooxy}ethanone, and benzophenone. Among them, 1-hydroxycyclohexyl phenyl ketone, 2-hydroxy-1-{4-[4-(2-hydroxy-2-methylpropionyl)benzyl]phenyl}-2-methylpropan-1-one, and 2-methyl-1-[4-(methylthio)phenyl]-2-morpholinopropan-1-one are preferred because the polymerization by the irradiation of ionizing radiation is initiated and accelerated by these compounds even in a small amount. These polymerization initiators may be used singly or in combination of two or more of them. These compounds are commercially available.

In the curable composition of the present invention, the polymerization initiator (d) is used in an amount of 0.1 to 25 parts by mass, preferably 0.1 to 20 parts by mass, and particularly preferably 1 to 20 parts by mass relative to 100 parts by mass of the polyfunctional monomer (c).

[Solvent (e)]

The curable composition of the present invention may be in a varnish form containing a solvent as component (e).

The solvent used in the varnish may be any solvent capable of dissolving the component (a) to the component (d). Examples of the solvent include aromatic hydrocarbons such as toluene and xylene; esters or ester ethers such as ethyl acetate, butyl acetate, isobutyl acetate, y-butyrolactone, methyl pyruvate, ethyl pyruvate, ethyl hydroxyacetate, ethyl lactate, butyl lactate, ethyl 2-hydroxy-2-methylpropionate, methyl 2-hydroxy-3-methylbutanoate, ethyl ethoxyacetate, methyl 3-methoxypropionate, ethyl 3-methoxypropionate, methyl 3-ethoxypropionate, ethyl 3-ethoxypropionate, methyl cellosolve acetate, ethyl cellosolve acetate, propylene glycol monomethyl ether acetate (PGMEA), and propylene glycol monopropyl ether acetate; ethers such as ethylene glycol monomethyl ether(methyl cellosolve), ethylene glycol monoethyl ether (ethyl cellosolve), ethylene glycol monobutyl ether (butyl cellosolve), diethylene glycol monomethyl ether, diethylene glycol monoethyl ether, and propylene glycol monomethyl ether (PGME); ketones such as acetone, methyl ethyl ketone (MEK), methyl isobutyl ketone (MIBK), cyclopentanone, and cyclohexanone; alcohols such as methanol, ethanol, propanol, isopropyl alcohol, butanol, isobutyl alcohol, octanol, and propylene glycol; and amides such as N,N-dimethylformamide (DMF), N,N-dimethylacetamide, and N-methyl-2-pyrrolidone (NMP). These solvents may be used singly or in combination of two or more of them.

Among these, ethers, ketones, and alcohols are particularly preferred.

In a case where the curable composition containing no solvent is desired to be used depending on circumstances, an active energy ray curable monomer different from the polyfunctional monomer (c) may be added as a diluent. Such a diluent monomer may be any monomer compatible with the component (a) to the component (d). Examples of the diluent monomer include (meth)acrylates such as methyl(meth)acrylate, tetrahydrofurfuryl(meth)acrylate, cyclohexyl(meth)acrylate, cyclohexyloxymethyl(meth)acrylate, tricyclo[5.2.1.0^{2,6}]decanyl(meth)acrylate (also called dicyclopentanyl(meth)acrylate), tricyclo[5.2.1.0^{2,6}]dec-3-enyl(meth)acrylate (also called dicyclopentenyl(meth)acrylate), 2-(tricyclo[5.2.1.0^{2,6}]dec-3-enyloxy)ethyl(meth)acrylate (also called dicyclopentenyloxyethyl(meth)acrylate), (2-ethyl-2-methyl-1,3-dioxolan-4-yl)methyl(meth)acrylate, (2-isobutyl-2-methyl-1,3-dioxolan-4-yl)methyl(meth)acrylate, 1,4-dioxaspiro[4.5]decan-2-ylmethyl(meth)acrylate, and benzyl(meth)acrylate.

The solid content in the curable composition of the present invention is, for example, 0.5 to 80% by mass, 1.0 to 70% by mass, or 1.0 to 60% by mass. Here, the solid content means all components of the curable composition except the solvent component.

[Other Additives]

The curable composition of the present invention may appropriately contain common additives such as photosensitizers, polymerization inhibitors, polymerization initiators, leveling agents, surfactants, adhesion imparting agents, plasticizers, ultraviolet absorbers, antioxidants, storage stabilizers, antistatic agents, inorganic fillers, pigments, and dyes, as necessary, as long as the effect of the present invention is not impaired.

<Cured Film>

The curable composition of the present invention can be applied onto a substrate and subjected to photopolymerization (curing) to form a molded article such as a cured film and a laminate.

Examples of the substrate include substrates of plastics (including polycarbonate, polymethacrylate, polystyrene, polyesters such as polyethylene terephthalate) (PET), polyolefin, epoxy, melamine, triacetyl cellulose, acrylonitrile-butadiene-styrene copolymers (ABS), acrylonitrile-styrene copolymers (AS), and norbornene resins), metal substrates, wood substrates, paper substrates, glass substrates, and slate substrates. The substrate may have a plate-like shape or a film-like shape, or be a three-dimensional molded body.

The coating method of the curable composition of the present invention can be appropriately selected from cast coating, spin coating, blade coating, dip coating, roll coating, spray coating, bar coating, die coating, ink-jet printing, printing (such as relief printing, intaglio printing, planographic printing, and screen printing), and other coating methods. Among them, the bar coating is preferably employed because it can complete the coating in a short period of time and thus a highly volatile solution can be used. In addition, it advantageously enables uniform coating easily. Alternatively, the spray coating is preferably employed because it enables coating easily and the curable composition of the present invention does not impair the lipophilicity even by the spray coating and can advantageously form a smooth surface without uneven coating. A curable composition in a varnish form can be suitably used here. It is preferable that the curable composition in the varnish form be filtered through a Inter having a pore size of about 0.2 μm beforehand and then be subjected to coating.

After the coating, the composition is subsequently, preferably pre-dried with an apparatus such as a hot plate and an oven, and then is photo-cured by irradiation with active rays such as ultraviolet rays. Examples of the active rays include ultraviolet rays, electron beams, and X-rays. Examples of the light source used for the ultraviolet irradiation include sunray, chemical lamps, low-pressure mercury lamps, high-pressure mercury lamps, metal halide lamps, and xenon lamps.

Subsequently, post-baking, specifically heating with an apparatus such as a hot plate and an oven, is carried out to complete the curing (polymerization).

The film formed by coating typically has a thickness of 0.01 to 50 μm, preferably 0.05 to 30 μm, and particularly preferably 0.1 to 30 μm after drying and curing.

<Laminate>

The present invention also relates to a laminate comprising a hard coat layer on at least one side of a substrate. The laminate is formed by the steps of applying the curable composition on the substrate to form a coating film and irradiating the coating film with ultraviolet rays to cure the coating film.

The substrate, the coating method, and the ultraviolet irradiation used here are the same as the substrate, the coating method, and the ultraviolet irradiation in the section <Cured Film> described above.

In the laminate, the hard coat layer preferably has a film thickness of 1 to 50 μm.

The hard coat layer of the laminate obtained from the curable composition of the present invention has smoothness and lipophilic properties (fingerprint resistance).

Therefore, the laminate of the present invention is useful as the material of a hard coat layer on the surface of various casings for electronic devices and cosmetics.

In the present invention, the fingerprint resistance means that fingerprints attached are unnoticeable and easily removed, and includes characteristics of inherently preventing fingerprints from adhering.

### EXAMPLES

The present invention will be described in further detail with reference to examples below, but is not limited to the examples.

In the examples, the following apparatuses and conditions were used for the preparation of samples and the analysis of physical properties.

### (1) C NMR Spectrum

Apparatus: JNM-ECA700 manufactured by JEOL datum Ltd.

Solvent: CDCl₃

Standard peak: CDCl₃ (77.0 ppm)

### (2) Gel Permeation Chromatography (GPC)

Apparatus: HLC-8220GPC manufactured by Tosoh Corporation

Column: Shodex (registered trademark) GPC KF-804 L, GPC KF-805 L manufactured by Showa Denko K. K.

Column temperature: 40° C.

Solvent: Tetrahydrofuran

Detector: RI

### (3) Measurement of Glass Transition Temperature (Tg)

Apparatus: Photo-DSC 204 F1 Phoenix (registered trademark) manufactured by NETZSCH

Measurement condition: Under a nitrogen atmosphere

Temperature increase rate: 5° C./min (25 to 160° C.)

### (4) Measurement of 5% Weight Loss Temperature (Td_{5%})

Apparatus: TG8120 manufactured by Rigaku Corporation

Measurement condition: Under an air atmosphere

Temperature increase rate: 10° C./min (25 to 500° C.)

### (5) Air Brush (Spray Coating)

Apparatus: HP plus (trademark) HP-TBCP manufactured by ANEST IWATA Corporation

Gas to be sprayed: nitrogen

Spray pressure: 0.2 MPa

Distance to be sprayed: 20 cm

### (6) Oven

Apparatus: dust-free oven DRC433FA manufactured by Advantec Toyo Kaisha, Ltd.

### (7) UV Irradiation

Apparatus: H02-L41 manufactured by Eye Graphics Co., Ltd.

### (8) Measurement of Contact Angle

Apparatus: DropMaster (trademark) DM-501 manufactured by Kyowa Interface Science Co., Ltd.

Measurement temperature: 20° C.

Measurement method: A contact angle was measured at 10 seconds after a measurement solvent attached on a film surface; the measurement was carried out five times for a single film; and the mean value was used as a contact angle value.

Abbreviations are as follows:
ADCP: tricyclo[5.2.1.0^{2,6}]decanedimethanol diacrylate [A-DCP manufactured by Shin Nakamura Chemical Co., Ltd.]
DCP: tricyclo[5.2.1.0^{2.6}]decanedimethanol dimethacrylate [DCP manufactured by Shin Nakamura Chemical Co., Ltd.]
PSPA: reactive silicone [Silaplane (registered trademark) FM-0721 manufactured by JNC, a weight average molecular weight Mw of 5,000]
STA: stearyl acrylate [STA manufactured by Osaka Organic Chemical Industry Ltd.]
ADVN: 2,2′-azobis(2,4-dimethylvaleronitrile) [V-65 manufactured by Wako Pure Chemical Industries, Ltd.]
DPCA60: butoxylated dipentaerythritol hexaacrylate [KAYARAD (registered trademark) DPCA-60 manufactured by Nippon Kayaku Co. Ltd.]
EB5129: hexafunctional urethane acrylate [EBECRYL (registered trademark) 5129 manufactured by DAICEL-CYTEC Co. Ltd.]
EB8402: bifunctional urethane acrylate [EBECRYL (registered trademark) 8402 manufactured by DAICEL-CYTEC Co. Ltd.]
EB860: bifunctional epoxidized soybean oil acrylate [EBECRYL (registered trademark) 860 manufactured by DAICEL-CYTEC Co. Ltd.]
UV7605B: polyfunctional urethane acrylate [SHIKOH (registered trademark) UV-7605B manufactured by The Nippon Synthetic Chemical Industry Co., Ltd.]
I184: 1-hydroxycyclohexyl phenyl ketone [IRGACURE (registered trademark) 184 manufactured by BASF Japan Ltd.]
B3440: acrylic leveling agent [BYK (registered trademark)—3440 manufactured by BYK Japan KK]
B3441: acrylic leveling agent [BYK (registered trademark)—3441 manufactured by BYK Japan KK]
B3500: silicone leveling agent [BYK (registered trademark)—UV3500 manufactured by BYK Japan KK]
B3530: silicone leveling agent [BYK (registered trademark)—UV3530 manufactured by BYK Japan KK]
B3570: silicone leveling agent [BYK (registered trademark)—UV3570 manufactured by BYK Japan KK]
B361N: acrylic leveling agent [BYK (registered trademark)—361N manufactured by BYK Japan KK]
PF75: acrylic leveling agent [Polyflow (trademark) No. 75 manufactured by Kyoeisha Chemical Co., Ltd.]
BC: butyl cellosolve
IBA: isobutyl alcohol
MIBK: methyl isobutyl ketone

### Reference Example 1

### Production of Lipophilic Highly Branched Polymer (Lipophilic HBP) Using ADCP, STA, and ADVN

Into a 300-mL reaction flask, 91 g of MIBK was placed, and nitrogen was flowed for 5 minutes while the solvent was stirred. The flask was heated until the solvent was refluxed (at about 116° C.).

Separately, into a 200-mL reaction flask, 6.1 g (20 mmol) of ADCP as the monomer A, 2.0 g (6 mmol) of STA as the monomer B, 4.0 g (16 mmol) of ADVN as the polymerization initiator C, and 91 g of MIBK were placed. Nitrogen was flowed into the flask for 5 minutes while the mixture was stirred to purge the system with nitrogen.

To the MIBK being refluxed in the 300-mL reaction flask, the contents in the 200-mL reaction flask, in which ADCP, STA, and ADVN had been placed, were added dropwise with a dropping pump over 30 minutes. After the completion of the dropwise addition, the mixture was stirred for another 1 hour.

Next, 163 g of MIBK was distilled off from the reaction solution with a rotary evaporator. The residue was added to 302 g of methanol, and the polymer was precipitated in a slurry form. The slurry was filtered under reduced pressure, and the collected polymer was dried under vacuum, thus yielding 6.6 g of a target compound (lipophilic HBP) as a white powder.

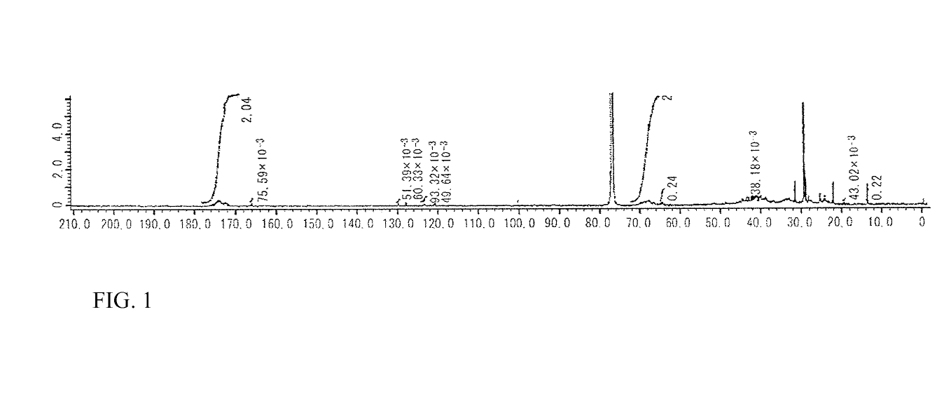

FIG. 1 shows a ¹³C NMR spectrum of the obtained target compound. The unit structure formulation (molar ratio) of lipophilic HBP of the structural formulae shown below, which was calculated from the ¹³C NMR spectrum, was a ratio ADCP unit [A]:STA unit [B]:ADVN unit [C] of 72:14:14. The target compound had a weight average molecular weight Mw of 7,100 measured by GPC in terms of polystyrene, a degree of distribution, Mw (weight average molecular weight)/Mn (number average molecular weight), of 2.4, a glass transition temperature Tg of 71.9° C., and a 5% weight loss temperature Td_{5%} of 327.6° C.

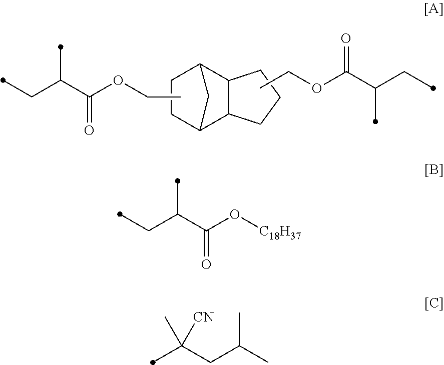

In the formulae, the black points are bonding terminals.

### Reference Example 2

### Production of Silicon-Containing Highly Branched Polymer (Si-HBP-1) Using DCP, PSPA, STA, and ADVN

Into a 300-mL reaction flask, 100 g of MIBK was placed, and nitrogen was flowed for 5 minutes while the solvent was stirred. The flask was heated until the solvent was refluxed (at about 116° C.).

Separately, into a 200-mL reaction flask, 6.7 g (20 mmol) of DCP as the monomer D, 1.0 g (0.2 mmol) of PSPA as the monomer E, 3.2 g (10 mmol) of STA as the monomer F, 3.0 g (12 mmol) of ADVN as the polymerization initiator G, and 100 g of MIBK were placed. Nitrogen was flowed into the flask for 5 minutes while the mixture was stirred to purge the system with nitrogen.

To the MIBK being refluxed in the 300-mL reaction flask, the contents in the 200-mL reaction flask, in which DCP, PSPA, STA, and ADVN had been placed, were added dropwise with a dropping pump over 30 minutes. After the completion of the dropwise addition, the mixture was stirred for another 1 hour.

Next, 186 g of MIBK was distilled off from the reaction solution with a rotary evaporator. The residue was added to 332 g of methanol, and the polymer was precipitated in a slurry form. The slurry was filtered under reduced pressure, and the collected polymer was dried under vacuum, thus yielding 4.1 g of a target compound (Si-HBP-1) as a white powder.

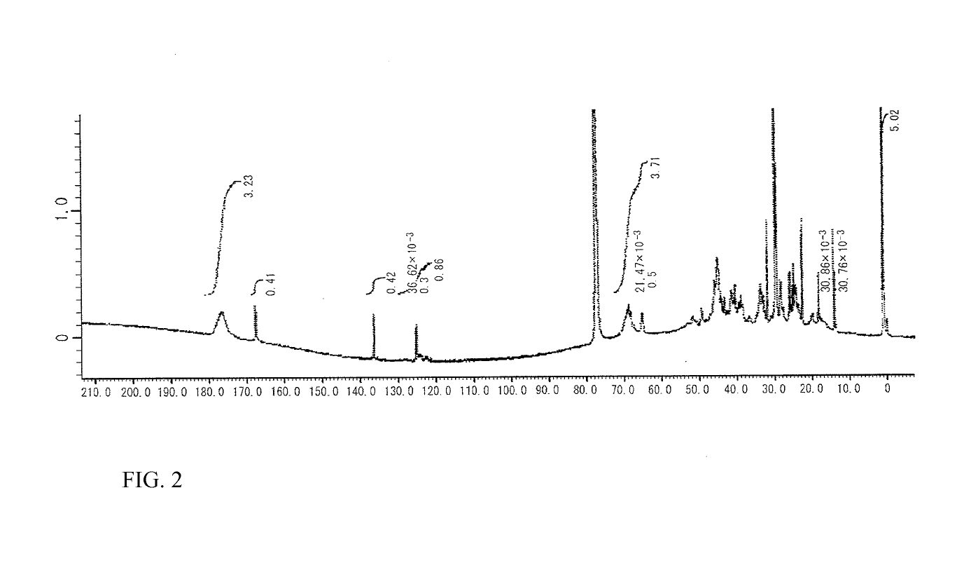

FIG. 2 shows a ¹³C NMR spectrum of the obtained target compound. The unit structure formulation (molar ratio) of Si-HBP-1 of the structural formulae shown below, which was calculated from the ¹³C NMR spectrum, was a ratio DCP unit [D]:PSPA unit

[E]:STA unit [F]:ADVN unit [G] of 69:1:21:9. The target compound had a weight average molecular weight Mw of 8,300 measured by GPC in terms of polystyrene, a degree of distribution Mw/Mn of 2.4, a glass transition temperature Tg of 70.7° C., and a 5% weight loss temperature Td_{5%} of 292.5° C.

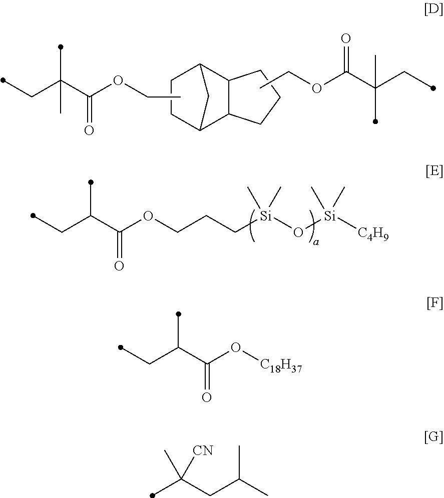

In the formulae, the black points are bonding terminals,

### Reference Example 3

### Production of Silicon-Containing Highly Branched Polymer (Si-HBP-2) Using DCP, STA, and ADVN

4.2 g of a target compound (Si-HBP-2) as a white powder was yielded in the same manner as in Reference Example 2 except that the amount of PSPA placed was changed to 0.5 g (0.1 mmol).

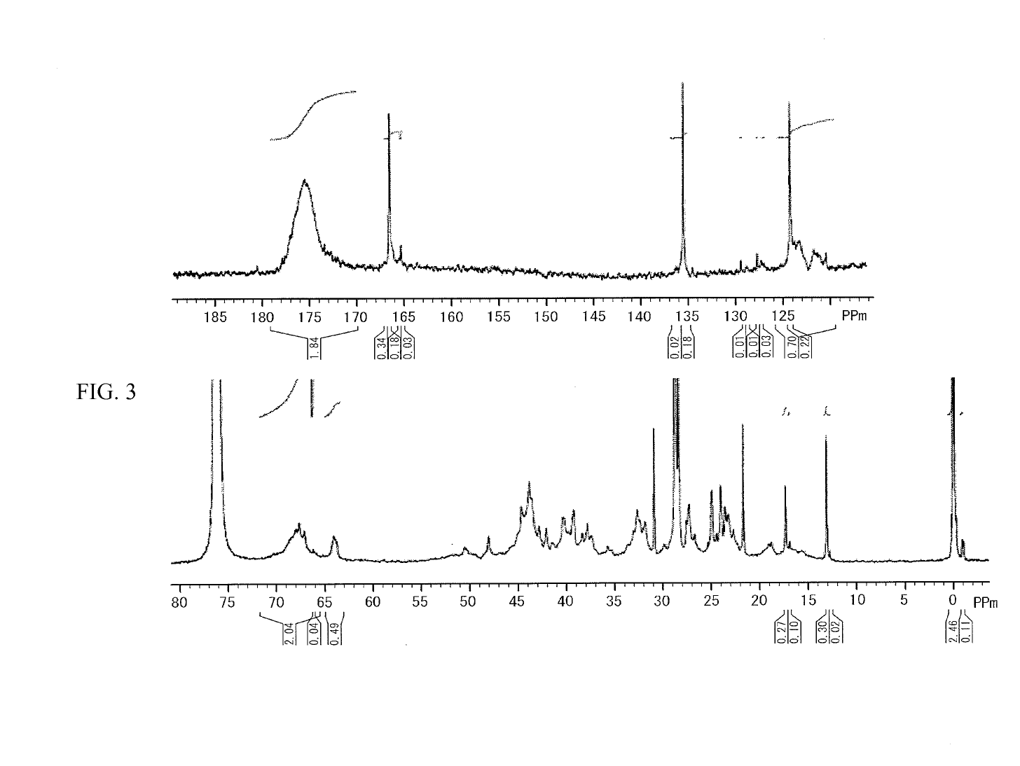

FIG. 3 shows a ¹³C NMR spectrum of the obtained target compound. The unit structure formulation (molar ratio) of Si-HBP-2 of the structural formulae shown below, which was calculated from the ¹³C NMR spectrum, was a ratio DCP unit [D]:PSPA unit [E]: STA unit [F]:ADVN unit [G] of 58:1:29:12. The target compound had a weight average molecular weight Mw of 7,600 measured by GPC in terms of polystyrene, a degree of distribution Mw/Mn of 2.4, a glass transition temperature Tg of 71.5° C., and a 5% weight loss temperature Td_{5%} of 293.7° C.

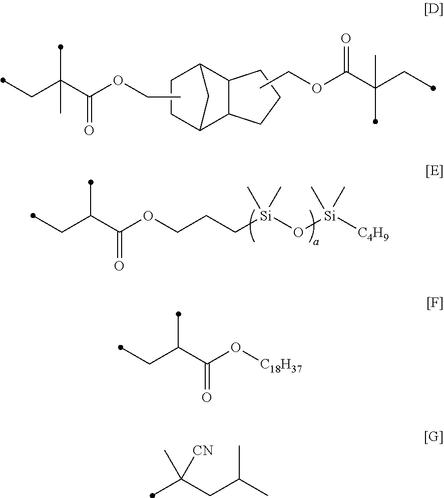

In the formulae, the black points are bonding terminals.

### Examples 1 to 5, Comparative Examples 1 to 7

### Production and Evaluation of Lipophilic Hard Coat 1

First, 63 parts by mass of UV7605B, 27 parts by mass of EB5129, and 10 parts by mass of EB8402 as the polyfunctional monomer (100 parts by mass of polyfunctional monomers in total), 1 part by mass of lipophilic HBP produced in Reference Example 1, the leveling agents described in Table 1, and 6 parts by mass of I184 as the polymerization initiator were dissolved in 606 parts by mass of a mixed solvent of acetone, IBA, MIBK, and BC (a mass ratio of 46/22/18/14) to obtain a curable composition having a solid content concentration of 15% by mass.

The curable composition was sprayed with an air brush for 30 to 60 seconds and applied onto the entire upper area of an ABS sheet [Rubber and Plastic Catalog for Research and Industry, #8000, code number: 07-147-03] having a thickness of 2 mm cut into dimensions of 55 X 90 mm. The sheet was dried in a dryer at 80° C. for 3 minutes and then irradiated with UV light at an exposure amount of 800 mJ/cm² to produce a lipophilic hard coat.

The water contact angle and the oleic acid contact angle of the obtained hard coat were measured. The smoothness of the hard coat surface was visually evaluated in accordance with the standard shown below. The results are summarized in Table 1.

### <Surface Smoothness Evaluation>

A: An obtained surface is smooth and has no unevenness.

B: An obtained surface has microscopic unevenness partially but is substantially smooth,

C: A hard coat surface has cellar unevenness in the entire area.

TABLE 1

| | | | Contact | | |
|---|---|---|---|---|---|
| | | | angle | | |
| | Leveling agent | | [degree] | | |
| | | Amount | | Oleic | Surface |
| | Type | [parts by mass] | Water | acid | smoothness |
| Example 1 | Si-HBP-1 | 0.05 | 93 | 33 | A |
| Example 2 | Si-HBP-1 | 0.01 | 89 | 13 | B |
| Example 3 | Si-HBP-2 | 0.05 | 96 | 27 | A |
| Example 4 | Si-HBP-2 | 0.01 | 89 | 9 | B |
| Example 5 | Si-HBP-2 | 0.001 | 88 | 11 | B |
| Comparative | None | — | UM* | UM* | C |
| Example 1 | | | | | |
| Comparative | B3500 | 0.05 | 101 | 50 | C |
| Example 2 | | | | | |
| Comparative | B3530 | 0.05 | 81 | 50 | C |
| Example 3 | | | | | |
| Comparative | B3570 | 0.05 | 101 | 23 | C |
| Example 4 | | | | | |
| Comparative | B361N | 0.05 | 88 | 27 | C |
| Example 5 | | | | | |
| Comparative | B3440 | 0.05 | 81 | 24 | C |
| Example 6 | | | | | |
| Comparative | B3441 | 0.05 | 85 | 28 | C |
| Example 7 | | | | | |

UM*: Unmeasurable due to excess roughness of a hard coat surface

As shown in Table 1, the hard coats (Examples 1 to 5) obtained from the curable composition of the present invention containing the silicon-containing highly branched polymers as the leveling agent had excellent surface smoothness and had lipophilicity indicated by a low oleic acid contact angle. In contrast, each of the hard coats (Comparative Examples 2 to 4) containing the silicone leveling agents as the leveling agent, the hard coats (Comparative Examples 5 to 7) containing the acrylic leveling agents, and the hard coat (Comparative Example 1) containing no leveling agent had an unsmooth surface with unevenness formed on the entire area.

### Examples 6 to 7, Comparative Examples 8 to 9

### Production and Evaluation of Lipophilic Hard Coat 2

Lipophilic hard coats were produced and evaluated in the same manner as in Example 1 except that 63 parts by mass of DPCA60, 27 parts by mass of EB860, and 10 parts by mass of EB8402 were used as the polyfunctional monomer (100 parts by mass of polyfunctional monomers in total) and the leveling agents described in Table 2 were used. The results are summarized in Table 2.

TABLE 2

| | | | Contact | | |
|---|---|---|---|---|---|
| | | | angle | | |
| | Leveling agent | | [degree] | | |
| | | Amount | | Oleic | Surface |
| | Type | [parts by mass] | Water | acid | smoothness |
| Example 6 | Si-HBP-2 | 0.01 | 101 | 14 | A |
| Example 7 | Si-HBP-2 | 0.005 | 85 | 10 | A |
| Comparative | None | — | UM* | UM* | C |
| Example 8 | | | | | |
| Comparative | PF75 | 0.05 | 60 | 10 | C |
| Example 9 | | | | | |

UM*: Unmeasurable due to excess roughness of a hard coat surface

As shown in Table 2, the hard coats (Examples 6 and 7) obtained from the curable composition of the present invention containing the silicon-containing highly branched polymers as the leveling agent had excellent surface smoothness and had lipophilicity indicated by a low oleic acid contact angle. In contrast, each of the hard coats (Comparative Example 9) containing the acrylic leveling agents as the leveling agent and the hard coat (Comparative Example 8) containing no leveling agent had an unsmooth surface with unevenness formed on the entire area.

1. A curable composition comprising:
0.01 to 10 parts by mass of a lipophilic highly branched polymer (a);
0.0001 to 1 part by mass of a silicon-containing highly branched polymer (b);
100 parts by mass of an active energy ray curable polyfunctional monomer (c); and
0.1 to 25 parts by mass of a polymerization initiator that generates radicals by an active energy ray (d), wherein
the lipophilic highly branched polymer (a) is a lipophilic highly branched polymer obtained by polymerization of a monomer A having two or more radically polymerizable double bonds in a molecule and a monomer B having a C₆₋₃₀ alkyl group or a C₃₋₃₀ alicyclic group and at least one radically polymerizable double bond in a molecule, in the presence of a polymerization initiator C in an amount of 5 to 200% by mole relative to the number of moles of the monomer A, and
the silicon-containing highly branched polymer (b) is a silicon-containing highly branched polymer obtained by polymerization of a monomer D having two or more radically polymerizable double bonds in a molecule, a monomer E having a polysiloxane chain and at least one radically polymerizable double bond in a molecule, and a monomer F having a C₆₋₃₀ alkyl group or a C₃₋₃₀ alicyclic group and at least one radically polymerizable double bond in a molecule, in the presence of a polymerization initiator G in an amount of 5 to 200% by mole relative to the number of moles of the monomer D.

2. The curable composition according to claim 1, wherein
the monomer D is a compound having at least one of a vinyl group and a (meth)acrylic group.

3. The curable composition according to claim 2, wherein
the monomer D is a divinyl compound or a di(meth)acrylate compound.

4. The curable composition according to claim 1, wherein
the monomer D is a compound having a C₃₋₃₀ alicyclic group.

5. The curable composition according to claim 4, wherein
the monomer D is tricyclo[5.2.1.0^{2,6}]decanedimethanol di(meth)acrylate.

6. The curable composition according to claim 1, wherein
the monomer E is a compound having at least one of a vinyl group and a (meth)acrylic group.

7. The curable composition according to claim 6, wherein
the monomer E is a compound of Formula [2]: 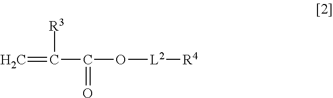
(where R³ is a hydrogen atom or a methyl group; R⁴ is a polysiloxane chain bonded to L² by a silicon atom; and L² is a C₁₋₆ alkylene group).

8. The curable composition according to claim 7, wherein
the monomer E is a compound of Formula [3]: 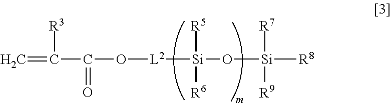
(where each of R³ and L² is the same as defined in Formula [2]; each of R⁵ to R⁹ is independently a C₁₋₆ alkyl group; and m is an integer of 1 to 200).

9. The curable composition according to claim 1, wherein
the monomer F is a compound having at least one of a vinyl group and a (meth)acrylic group.

10. The curable composition according to claim 9, wherein
the monomer F is a compound of Formula [4]: 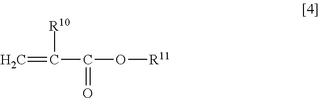
(where R¹⁰ is a hydrogen atom or a methyl group; and R¹¹ is a C₆₋₃₀ alkyl group or a C₃₋₃₀ alicyclic group).

11. The curable composition according to claim 2, wherein
the polymerization initiator G is an azo polymerization initiator.

12. The curable composition according to claim 1, wherein
the silicon-containing highly branched polymer (b) is a silicon-containing highly branched polymer obtained by using the monomer E in an amount of 0.01 to 10% by mole and the monomer F in an amount of 10 to 300% by mole relative to the number of moles of the monomer D.

13. The curable composition according to claim 1, wherein
the monomer A is a compound having at least one of a vinyl group and a (meth)acrylic group.

14. The curable composition according to claim 13, wherein
the monomer A is a divinyl compound or a di(meth)acrylate compound.

15. The curable composition according to claim 1, wherein
the monomer A is a compound having a C₃₋₃₀ alicyclic group.

16. The curable composition according to claim 15, wherein
the monomer A is tricyclo[5.2.1.0^{2,6}]decanedimethanol di(meth)acrylate.

17. The curable composition according to claim 1, wherein
the monomer B is a compound having at least one of a vinyl group and a (meth)acrylic group.

18. The curable composition according to claim 17, wherein
the monomer B is a compound of Formula [1]: 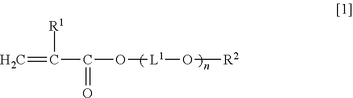
(where R¹ is a hydrogen atom or a methyl group; R² is a C₆₋₃₀ alkyl group or a C₃₋₃₀ alicyclic group; L¹ is a C₂₋₆ alkylene group; and n is an integer of 0 to 30).

19. The curable composition according to claim 18, wherein
n is 0.

20. The curable composition according to claim 13, wherein
the polymerization initiator C is an azo polymerization initiator.

21. The curable composition according to claim 1, wherein
the lipophilic highly branched polymer (a) is a lipophilic highly branched polymer obtained by using the monomer B in an amount of 5 to 300% by mole relative to the number of moles of the monomer A.

22. The curable composition according to claim 1, wherein
the polyfunctional monomer (c) is at least one selected from the group consisting of polyfunctional (meth)acrylate compounds and polyfunctional urethane (meth)acrylate compounds.

23. The curable composition according to claim 1, wherein
the polymerization initiator (d) is an alkylphenone compound.

24. The curable composition according to claim 1, further comprising a solvent (e).

25. A cured film obtained from the curable composition as claimed in claim 1.

26. A laminate comprising:
a hard coat layer on at least one side of a substrate, wherein
the hard coat layer is formed by the steps of applying the curable composition as claimed in claim 1 onto the substrate to form a coating film and irradiating the coating film with ultraviolet rays to cure the coating film.

27. The laminate according to claim 26, wherein
the application of the curable composition is performed by spray-coating in the step of forming the coating film.

28. The laminate according to claim 27, wherein
the hard coat layer has a film thickness of 1 to 50 μm.
